(19) United States
(12) Patent Application Publication
(10) Pub. No.: US 2026/0115103 A1
(43) Pub. Date: Apr. 30, 2026

(54) Device for Storing, Organizing, and Dispensing Solid Dose Medications

(71) Applicant: Nabeel Rustam Ali, Sugar Land, TX (US)

(72) Inventor: Nabeel Rustam Ali, Sugar Land, TX (US)

(21) Appl. No.: 17/803,188

(22) Filed: May 21, 2021

(51) Int. Cl. A61J 7/04; B65D 83/04

(52) U.S. Cl. CPC A61J 7/0454; A61J 7/0418; B65D 83/04

(57) ABSTRACT

A cylindrical storage-organizer-dispenser device for solid dose medications, arranged in a 7-day by time-interval-dose matrix, specifically invented to offer a simple, user-friendly, and secure way for people who need to take multiple daily medications on a weekly basis. The device permits to visually see what medications have been already taken and implicitly indexes to the next upcoming dose; this helps to avoid missing a dose or taking dangerous double doses. Additionally the device provides secure storage for emergency medication, specific patient information and/or medication instructions, and includes a feature to securely carry it around.

### FIELD OF THE INVENTION

The present invention relates to an efficient, organized, safe, easy to use, and improved method of temporary storage for later dispensing solid medication dosages in the form of tablets, capsules, and pills.

### BACKGROUND OF THE INVENTION

In general, patients need to take at specific times one, two, or more different medications on a daily basis. Unfortunately, way too often patients lose track of which medication they have taken, which can lead to skipping a much needed dose or worse, the danger of taking a double dose medication. The problem is even greater when multiple medications need to be taken-this unwanted situation could lead to dangerous situations or could even cause death. Existing devices attempted to address these needs, but fail to provide the means to guide thru the medication process and safe dosage.

### DESCRIPTION OF THE PRIOR ART

Existing devices have been developed and are widely available in the market that attempt to overcome the problem of organizing solid dose medications, but most lack: compact storage, logic organization, tracking control, intuitive guidance, easy access, and safety. As result of sustained injury, post-surgery, chronic illness, or physical challenges (cause by age), many people required to take medications daily at regular intervals and thru days, weeks, or even permanently. Often the doctors prescribe various medications for the effective treatment and some of those medications must be taken exactly in the prescribed amount and frequency, including combination of different medications and multiple times a day. It is recognized that especially elderly patients may easily get confuse and fail to remember if a medication was taken or not and they could be unsure of what medication should be taken next. Not following the precise dosage and required frequency could lead to dangerous health episodes, especially when a patient takes a double dose of a powerful medication.

Many pill organizer devices are known and have been implemented in a format similar to that of a calendar, being each day of the week or month an actual compartment where the pills are stored. A patent search for this utility type device revealed a number of devices which are briefly described below for comparison with the existing prior art, with the purpose of showing their deficiencies as well as to differentiate the originality and functionality of this invention by addressing and solving such limitations.

U.S. Pat. No. D704,930-S to Murphy, Jr. discloses an ornamental medicine organizer that exhibits seven triangular shaped storage areas for each day of the week arranged in a circular pattern (resembling a lantern), each having a front door to access larger medications and two symmetrical triangle-shaped drawers to contain AM and PM medications. The device also has on its top a rotary knob with an engraved arrow that is used to point to the current weekday. The device is big to accommodate medications of larger volume than pills, tablets and capsules, but it has a limitation of two pills compartments per day and fails to secure any of the contained medications and provides no indication of the last dose taken or guidance for the next dose.

U.S. Pat. No. 6,779,663 to POCSI discloses a system and method for loading a pillbox comprising both, a loader and a pillbox, the later has multiple compartments, but fails to disclose the pillbox capability to indicate the day and time when the user should take the medication.

U.S. Pat. Nos. D851,391-S and 10,524,986-B2 to Meritt disclose an ornamental pill organizer which consists of a container with seven enclosed rectangular storage compartment areas linearly arranged to hold respective pill holders, also having an additional section for a pill cutter. The device fails to identify the purpose of each storage area, fails to provide multiple medication storage within each compartment, and fails to provide any indication of previous dose taken or next dose to take.

U.S. Pat. No. D889,118-S to Lee discloses an ornamental pill organizer consisting of a main box designed to accommodate fourteen boxes of pills arranged in a 2×7 geometric configuration and U.S. Pat. No. D898,345-S to Lee also discloses an ornamental pill box to be used in the previously described pill organizer. These devices fail to identify the purpose of each storage area, fail to provide multiple medication storage within each compartment, and fail to provide any indication of previous dose taken or next dose to take.

U.S. Pat. No. 8,253,561 to BOWERS discloses a medication management device as a pill organizer having seven rows (for the seven days of the week) of rectangular compartments for storing the pills. The device is equipped with electronics to allow the user to input and store pill's information. Nevertheless, Bowers discloses a pill organizer having multiple compartments representing each day of the week, but fails to provide individual multiple doses per day and to automatically prove the last dose taken and indexing to the next dose time.

U.S. Pat. No. 6,631,805-B2 to Bramen discloses a pill dispenser device comprising a tray with a hinged lid, designed to accept multiple compartments arranged in a linear fashion. The compartments have their own lid and relate to every weekday with a marking for each day's initial. The device key feature consists of an improved safety latch, but the device fails also to provide multiple medication storage within each compartment, and fails to provide any indication of previous dose taken or next dose to take.

U.S. Pat. No. 6,860,390-B2 to Bowman discloses a medicine organizer device consisting of a box or briefcase having its base equipped with a number of holes arranged in seven columns by three rows that will be used to hold the small bottles or tubes containing the medications. These holes can be labeled for days and medication dose intervals. This device may help with tracking of medications taken by relying on the user to return the empty tube (or bottle) to the case placing it on an inverted position, but, because of that dependency, it fails to provide a positive and automatic way to track the proper dose.

U.S. Pat. No. 7,004,324-B1 to Delorio discloses a multi-compartment pill device devised to hold a week's worth of medications stored on individual removable compartments which are secured by the housing lid. The compartments are labeled with the days of the week and they have various chambers used to hold the various daily dose medications. The device is also equipped with a timer to remain the user to take medication. While the medication's organization is practical and the timer helps the user to take medication, the device does not provide a memory of what medication dose has been taken nor enforces the next dosage safely.

U.S. Design Pat. No. D576,404 to COOPER discloses the ornamental design of a pill organizer having each day of the month represented by a compartment. The pill organizer also includes a digital clock and calendar for displaying the day and time. The format is simple, but it assumes that medication(s) are taken just once a day. Therefore, given that many patients must take multiple medications during the day, this invention fails to address this very basic need.

In general, all these (and many other) prior art devices exhibit multiple problems, as they do not provide containers organized in a logical intuitive fashion, nor will they prevent a user from taking a dose that doesn't correspond to the actual day and time. Furthermore, these devices do not provide a means for tracking the last medication taken, and do not point automatically to the next medication to be taken, and do not provide a means of storing patient or medication documents, and do not have a feature to carry them securely.

After reviewing the prior art devices, it is obvious that the present invention substantially diverges in design format, features, and functions from the known prior art, and consequently, it is clear that there is room for improvements to existing solid dose medication organizer devices. Therefore, the present invention substantially fulfills all these needs.

### BRIEF SUMMARY OF THE INVENTION

The present invention successfully overcomes all of the previously expressed limitations, offering a number of improvements and advantages that simplify and safely enable the patient's daily medication.

The special focus of this invention has been to deliver an intuitive solution to store, organize, and dispense solid-dose medications, and doing so safely by means of providing an easy to use geometry with a built-in smart mechanical feature. This unique feature serve three purposes: 1) to lock the dispensing ring in the closed position, 2) to stay in the last position of the last dose taken as a reminder for the user, and 3) to only allow the ring to move towards the next dose to be taken.

Furthermore, each medication section is clearly identified with the day of the week, and each dose cavity with the time period within each day.

Additionally, this device includes two compartments where documents related to the patient-user or medications'instructions can be store.

Also, should more than one patient reside in the same location, this invention has a pre-determined area where a label can be attach to identify the patient-user for each existing device.

Each cavity storage compartment has been sized to have sufficient capacity to store multiple medications of the same kind or combination of different ones.

The Finally, built-in feature that can be used to avoid losing the device while carrying it around by means of inserting a security strap thru its terminating cover.

### BRIEF DESCRIPTION OF THE DRAWINGS

A further understanding of the present invention can be gained by reference to a preferred embodiment set forth in the illustrations provided in the accompanying drawings. The intention of the drawings is not to limit the scope of this invention, but to help in clarifying the details and originality of the invention and may be easily understood by reference to the drawings and the following descriptions:

FIG. 1 represents a complete device of this invention fully assembled (shown with all the dispensing rings turned to the CLOSED rest position where the weekday labels are) indicating each of the external elements of the system in accordance with the preferred embodiment of the present invention.

FIG. 2 illustrates some dosage time-interval labels placed over each of the multi-cavity storage sections of the device (the dispensing rings have been removed for clarity).

FIG. 3 illustrates an exploded and complete view of all the basic parts comprising this invention.

FIG. 4 shows a one-day multi-cavity storage section of the assembled device having all storage compartments filled with random solid dose medications and the dispensing ring open on the afternoon cavity position to expose the medications ready to be dispensed.

FIG. 5 illustrates on a one-day multi-cavity storage section with the dispensing ring removed, the weekday and time-interval identification labels within the day for the first two storage cavities of the device: DAY OF THE WEEK, MORNING, and NOON.

FIG. 6 illustrates on a one-day multi-cavity storage section with the dispensing ring removed, the time-interval identification labels within the day for the remaining three storage cavities of the device: AFTERNOON, EVENING, and NIGHT.

FIG. 7 discloses the smart feature that makes possible the retention of the dispensing control ring on each of the rotational positions: CLOSED (over the weekday), MORNING, NOON, AFTERNOON, EVENING, and NIGHT.

FIG. 8 is an isometric drawing of the clear (see thru) dispensing control ring.

FIG. 9 discloses the smart feature that blocks the dispensing control ring from going backwards and forces the user to advance towards the next time interval dose within the day.

FIG. 10 reveals the device with the end cover removed to show the multi-cavity storage compartments for patient data and medication instruction documents.

FIG. 11 is an isometric drawing of the base hexagonal-column.

FIG. 12 is an isometric drawing of the termination and closure combination cap.

FIG. 13 points out the location to affix the patient's identification label.

FIG. 14 discloses the device's optional desktop holder.

FIG. 15 demonstrates the usefulness of using the device when supported over the optional desktop holder to facilitate the loading of medications into the multi-cavity storage compartments.

FIG. 16 depicts the complete device with the optional safety strap attached.

FIG. 17 represents an alternate embodiment of this invention demonstrating the basic concept as a single day multi-dose organizer.

FIG. 18 shows another alternate embodiment of this invention where its diameter has been drastically reduced and the width of each day has been increased.

FIG. 19 represents a one day multi-cavity section of the alternate embodiment shown on the previous FIG. 18.

FIG. 20 discloses an alternate embodiment of this invention where the single day has seven cavities for time-interval doses and the time-interval labels are marked with ‘hours’ instead of ‘parts of the day’.

FIG. 21 discloses an alternate embodiment of this invention where the single day has seven cavities for time-interval doses and the time-interval labels are marked with ‘hours’ using a standard numeral format instead of words describing ‘parts of the day’.

FIG. 22 illustrates a one day and seven time-interval section equipped with the dispensing control ring with its open window being resized to fit the seven time-intervals.

FIG. 23 is a top view of the seven time-interval section showing the equal medication storage cavities and the storage compartments for patient data and/or medication instruction documents.

FIG. 24 demonstrates another alternate embodiment in which the device has been expanded to support twelve day medication.

### DETAILED DESCRIPTION OF THE INVENTION'S PREFERRED EMBODIMENT

All illustrations of the drawings and descriptions of the embodiments are for the purpose of describing selected versions of the present invention and are not intended to limit the scope of the present invention.

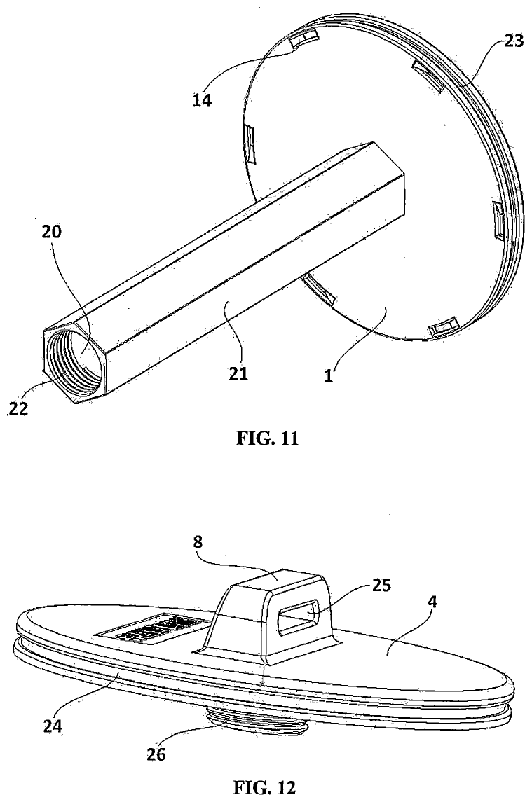

The design of the present invention is based around a cylindrical geometry similar to a bottle and it is created by assembling a number of sections formed by individual parts (all of these parts can be molded out of various materials, most commonly plastics), including one base hexagonal-column (FIG. 11—1), seven five-cavity storage circular containers, seven clear access control rings, one termination-closure cap, and it can be complete with a couple of accessories, one security strap and one desktop device holder to ease the loading of medications. The device if formed by alternating the insertion of one access control ring and one five-cavity container over the hexagonal base column and doing this for all seven access control rings and seven five-cavity containers, and finishing the assembly with the termination and closure combination cap.

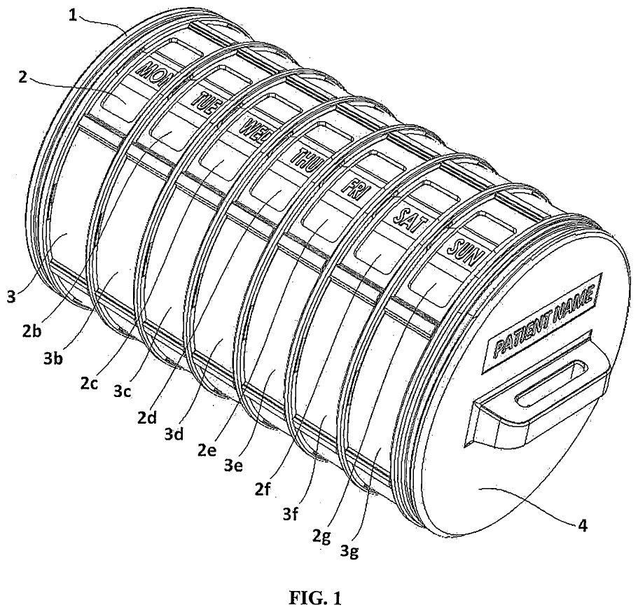

The present invention depicted in FIG. 1 relates to a device and method for storing and dispensing solid dose medications using an organized matrix structure with safekeeping of the medications, automatic retention of last dose, automatic indexing to the next dose, safe storage of patient and/or medication documents, optional medication loading accessory, and a strap for carrying the device safely.

It is an objective of the present invention to address a very real problem humans face too frequently: the necessity of taking one or multiple medications at fixed intervals within the day for extended periods of time and the fact that—at times—a patient may or may not remember if a given medication dose was taken on time or which will be the next medication dose to take. The present invention provides a practical and secure solution to those potentially serious problems and it does so by providing a simply easy to use device.

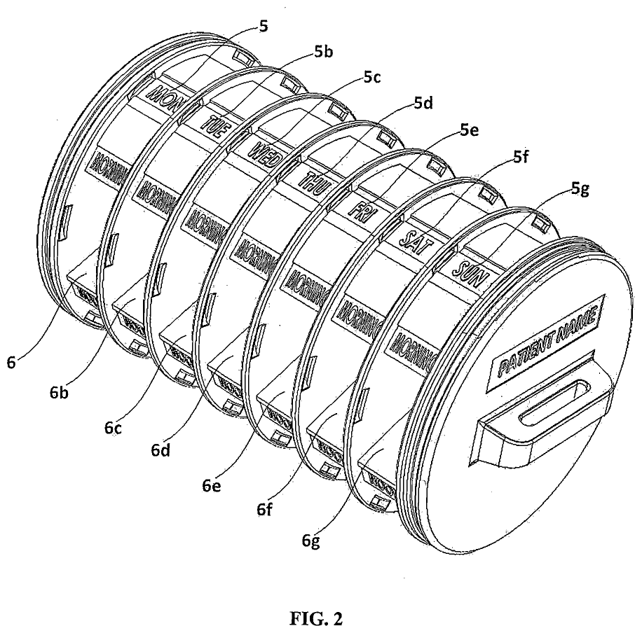

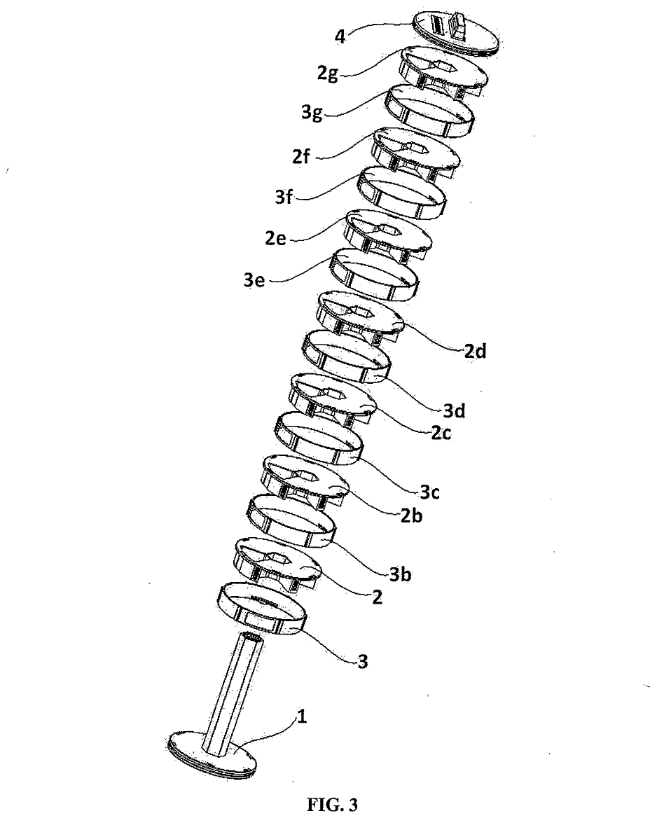

Specifically by design, the present invention comprises a base-hexagonal-column (FIG. 3—1), multiple multi-cavity storage compartments (FIG. 3—2, 2b, 2c, 2d, 2e, 2f, 2g), multiple dispensing control rings (FIG. 3—3, 3b, 3c, 3d, 3e, 3f, 3g), a termination and closure combination cap (FIG. 3—4), weekday identification labels (FIG. 2—5, 5b, 5c, 5d, 5e, 5f, 5g), time-interval identification labels (FIG. 5—9, 10, and FIG. 6—11, 12, 13), along with an optional desktop holder (FIG. 14—27) and a safety strap (FIG. 16—29).

The base hexagonal-column (FIG. 11—1) has a 360 degree depression (FIG. 11—23) at its base so that it can rest on the optional desktop holder's edges (FIG. 14—28 or 28b , depending on orientation), also has a number of depressions (FIG. 11—14) to engage with the corresponding protrusions of the dispensing control ring, then its body extends thru a hexagonal column (FIG. 11—21) which serves as the core structure to assemble the complete device; such hexagonal feature is hollow to provide space to store medication or patient documents and it is terminated with an inner thread designed to receive the termination and closure combination cap, (FIG. 12—4) via its matching thread (FIG. 12—26).

To be able to rest the device onto the optional desktop holder the termination and closure combination cap also has a 360 degree depression (FIG. 12—24) so that—once the device is fully assembled-it can rest on the optional desktop holder's edges (FIG. 14—28b or 28 , depending on orientation).

A final feature of the termination and closure combination cap is a handle (FIG. 12—8) equipped with a slot (FIG. 12—25) making possible to pass thru a safety strap (FIG. 16—29).

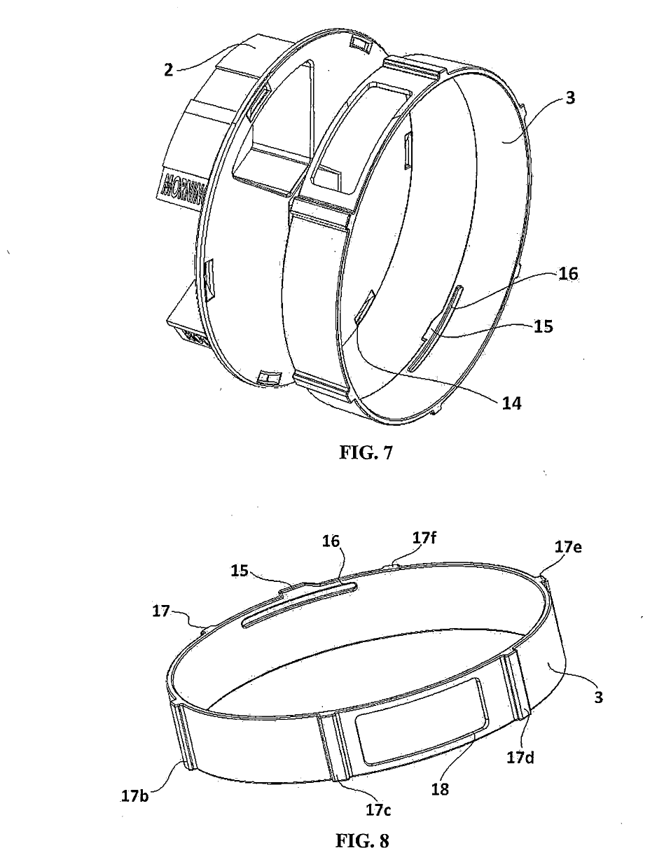

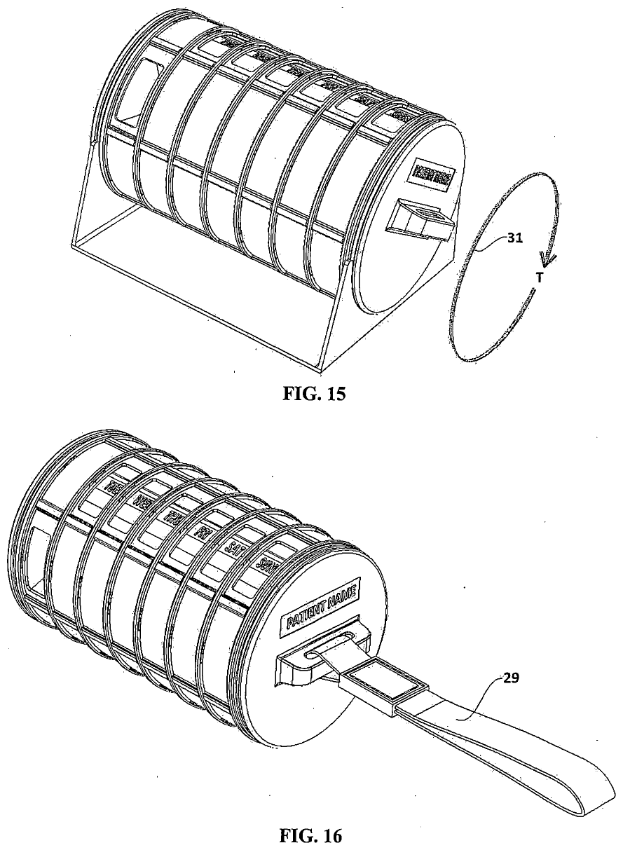

A procedure to fill an empty device with the prescribed medications is (preferably) done using the optional desktop holder (FIG. 14—27) conveniently placed on a tabletop. Initially all dispensing control rings will be rotated until the dispensing window (FIG. 8—18) reaches the CLOSED position such that it will expose the weekday labels, as depicted in FIG. 1. At that point, the device will be rotate counter-clock-wise (FIG. 15—31) so that the first storage cavity faces the person loading the medications. Then, to fill medications in the first section (MONDAY) the dispensing control ring will be rotated clock-wise to expose the storage cavity labeled MORNING. At this point, the necessary medication(s) will be placed into said cavity. Next, the device will be rotate counter-clock-wise and the same dispensing control ring will be rotated clock-wise to expose the storage cavity labeled NOON to permit the stuffing of the corresponding medication(s). The process will be repeated for the rest of storage cavities AFTERNOON, EVENING, and NIGHT. Once all cavities have been loaded the dispensing control ring will be rotated clock-wise one more time to reach the CLOSED position (corresponding to the weekday label). Now that the MONDAY section has been fully loaded, the exact same procedure will be used to fill the rest of the storage cavities in the remainder weekdays'sections. When the device has been fully loaded with medications all of the dispensing control rings will be left in the CLOSED position with their dispensing window over the weekday locations.

Specifically by design, the present invention includes a unique part, the dispensing control ring (FIG. 8—3) that provides multiple functions, as follows,

The first function consists of six radial protrusions (FIG. 8—17, 17b, 17c, 17d, 17e, 17f) equally spaced 60 degrees over the outer surface of the dispensing control ring and the purpose of these protrusions is to provide multiple gripping points to help with the rotation of the part in reaching each of the dispensing and closed locations.

Another function consists of a single access window (FIG. 8—18) that serves as the only way of loading and dispensing medications, when rotate to the desired radial position.

One more function consists of a protrusion (FIG. 7—15) located on one edge of the dispensing control ring and when it engages with any of the six depressions (FIG. 7—14) of the five-cavity storage circular container (FIG. 7—2) serves to retain the dispensing control ring on any of the six radial positions, identified as: CLOSED (weekday), MORNING, NOON, AFTERNOON, EVENING, and NIGHT. This is a key function for the device as it renders the capacity to keep the medications enclosed and/or memorize the last dose taken.

Furthermore, the previously described protrusion (FIG. 9—15) features asymmetric geometry; one side-edge abruptly ends at 90 degrees, while the opposite side-edge exhibits a shallow 30 degree slope. When trying to rotate the ring, the user would not be able to go turn it back (counter-clock-wise) towards a previous location as its 90 degree edge will lock against the corresponding 90 degree edge of the depression (FIG. 9—14) of the five-cavity storage circular container; therefore this key feature will only allow the dispensing control ring to rotate forward (clock-wise) towards its 30 degree edge of the depression (FIG. 9—14), thus enforcing the user to fetch the next corresponding time-interval dose. The elongated curved double arrow designated ‘R’ with markings ‘×’ and ‘✓’ in FIG. 9 may or may not be imprinted on the dispensing control rings, but it is shown on that figure to illustrate this important function.

It's noteworthy to mention that, while the dispensing control ring is rotate from one position to the next, the described protrusion (FIG. 9—15) flexes inwards in the direction shown by the arrow marked ‘F’ (this graphic markings will not be in the final device but are shown herein for clarification of the function) and such motion is enabled by the elongated cut (FIG. 9—30) which acts as a intrinsic spring.

All weekdays'labels (FIG. 2—5, 5b, 5c, 5d, 5e, 5f, 5g) could be implemented by embedding them on the molded parts or made independently and then affixed in the corresponding spaces.

Likewise, all time-interval dosage labels (FIG. 5—9, 10, and FIG. 6—11, 12, 13) could be implemented by embedding them on the molded parts or made independently and affixed in the corresponding spaces.

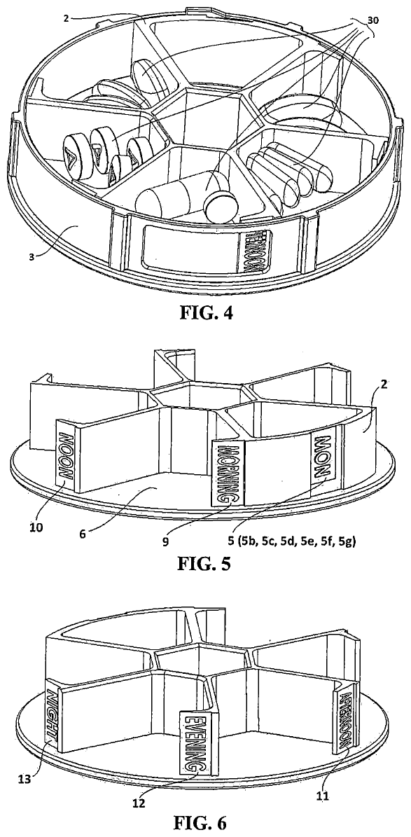

Each cavity storage compartment (FIG. 5—6) has been sized to have sufficient capacity to store multiple medications of the same kind or combination of different ones (FIG. 4—30).

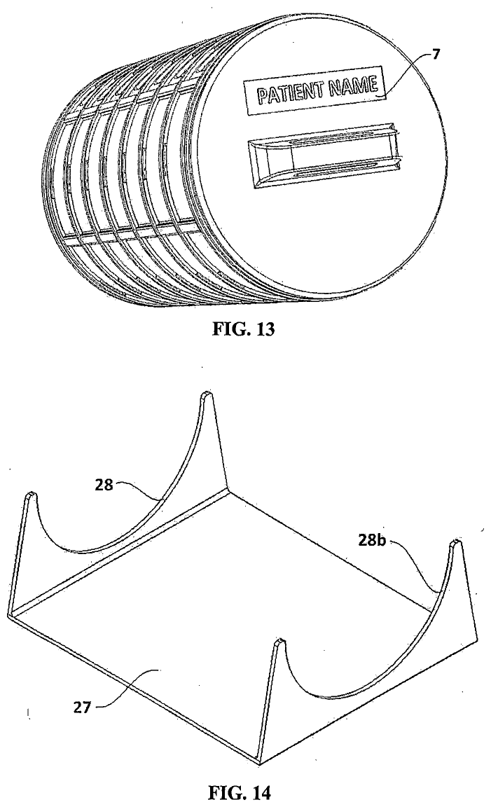

Should more than one patient reside in the same location, this invention has a pre-determined area (FIG. 13—7) where a label can be attach to identify the patient-user for each existing device.

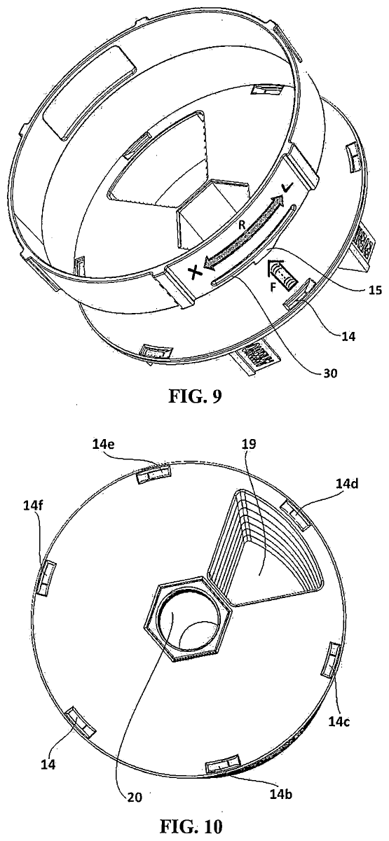

This invention includes two compartments (FIG. 10—19, 20) where documents related to the patient-user or medications'instructions can be store.

### DESCRIPTION OF AN ALTERNATE EMBODIMENT

A general understanding of the herein disclose invention clearly opens many other possible applications of the described preferred embodiment and the description given is sufficient so that any person of ordinary skill in the related art could make and use the invention without extensive experimentation.

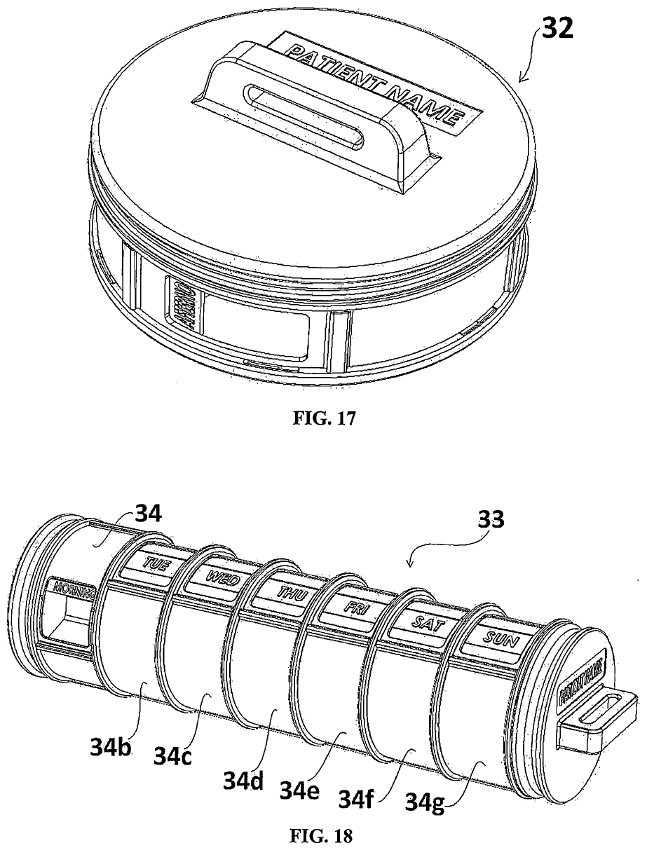

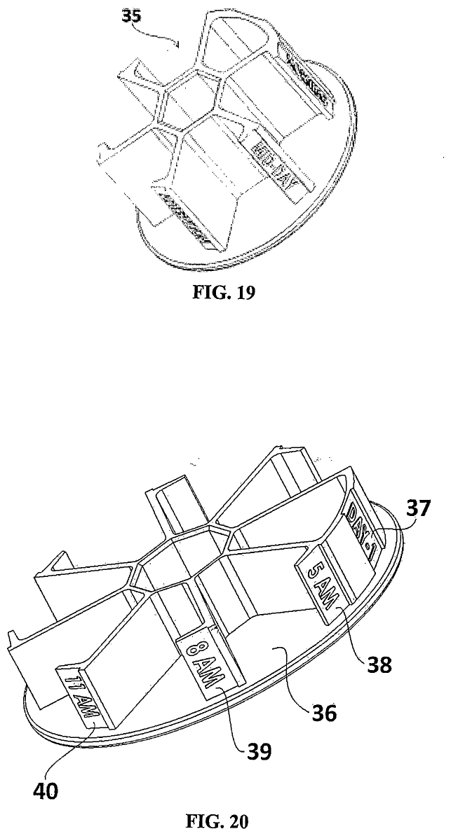

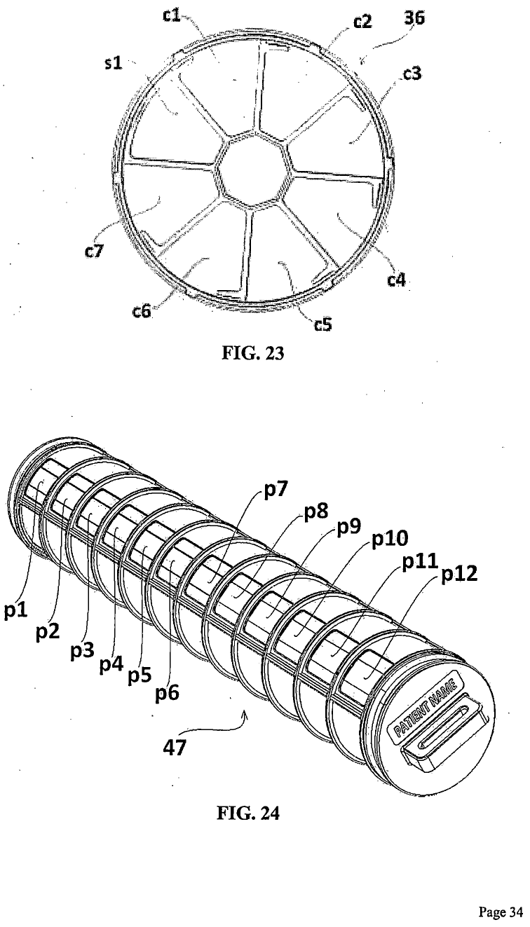

Although the preferred embodiment had presented what's is considered at the time of preparing this document a design with an optimal set of features and parameters, this invention can be scaled up by expanding the multi-cavity storage WEEKDAY sections (FIG. 24—47) to many periods (FIG. 24—p1, p2, p3, p4, p5, p6, p7, p8, p9, p10, p11, p12) or contracting down to one single section (FIG. 17—32) and the number of storage cavities per section can also be decreased from five down to one or increased from 5 to 6, 7 (FIG. 23—36), or more. Also, the overall height and diameter of each storage cavity (FIG. 19—35) can be modified creating a device with a varying aspect ratio (FIG. 18—33) to accommodate smaller or larger medications; a complete device exhibiting such characteristics is shown on FIG. 18—33 where the dispensing control rings have also been resized (FIG. 22—45) as well as its dispensing window (FIG. 22—46) to permit access to the medications while showing the corresponding time-interval marking (FIG. 22—41). The dispensing control ring over the MONDAY section (FIG. 18—34) is shown open over the MORNING time-interval and the remaining dispensing control rings (FIG. 18—34b, 34c, 34d, 34e, 34f, and 34g) are shown in their closed position.

In addition, markings for WEEKDAY sections can be changed (FIG. 20—37) to reflect particular applications (i.e.: DAY-1, DAY-5, etc. instead of MON, TUE, etc.).

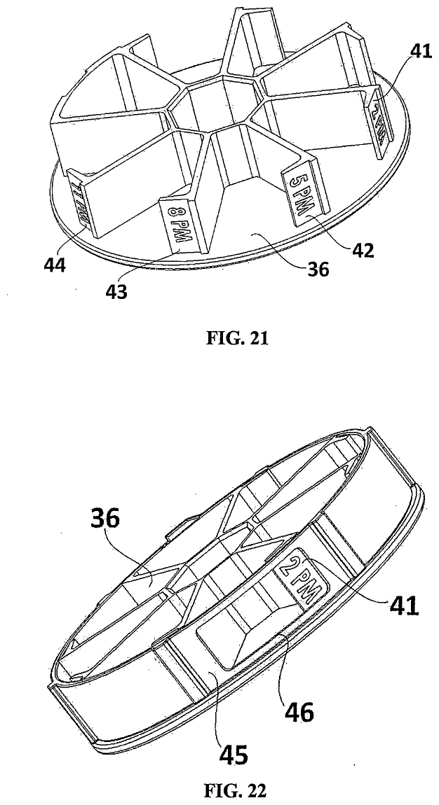

Likewise, markings for time-intervals can be changed from MORNING, NOON, etc., to time of the day in the standard numeric format, such as 8 AM, 11 AM, etc. (FIG. 20—38, 39, 40 and FIG. 21—41, 42, 43, 44).

If the multi-cavity storage section (FIG. 23—36) overall size is modified and the number of storage cavities is increased (FIG. 23—c1, c2, c3, c4,l c5, c6, c7) or decreased, the storage compartment (FIG. 23—s1) for patient data and medication instruction documents will also change in its volumetric capacity.

Also, the inner cylinder and outer dimensions of the hexagon and total length of the base's hexagonal-column can also be modified matching the other parts to accommodate any specific usage of the device. This key component that holds the entire device together could also be shaped as a triangle, square, pentagon, hexagon, etc. depending on the desired number of time-intervals. Several devices exhibiting dimensional changes have been already modeled and prototyped successfully to test and confirm multiple uses.

Furthermore, is obviously clear that devices can be constructed to any number of multi-cavity storage sections by stacking them end-to-end.

Finally, while the chosen materials in the preferred embodiment for producing this device are plastics (especially plastics that can be easily decontaminated), it is clearly understood that the device can also be made using many other materials.

What is claimed is:

1. An organizing device for storing and dispensing tablets, capsules, and pills medication dosages, comprising
A base hexagonal column
Multiple cavity storage containers
Multiple clear (see thru) access control rings
A termination and closure combination cap
A safety strap
A desktop device holder

2. An organizing device of claim 1 that provides a method of organizing the daily medication solid doses within clearly identified and independent seven weekdays section arrays.

3. An organizing device of claim 2 having a feature that defines the organization of multiple time-interval doses per each day of the week.

4. An organizing device of claim 1 having a positive detent safety feature on each access control ring that keeps all medications stored safely.

5. An organizing device of claim 1 comprising a number of clear (see thru) access control rings to provide visual verification of medication content of each cavity storage compartment.

6. An organizing device of claim 1 comprising an intrinsic sequential feature to enforce the orderly load of medications.

7. An organizing device of claim 3 comprising an intrinsic feature capable of retaining which dose was the last medication taken.

8. An organizing device of claim 3 comprising a dispensing feature that forces to fetch the correct next dose period.

9. An organizing device of claim 1 having a double built-in storage for critical medical records and/or medication instructions or notes.

10. An organizing device of claim 1 including a mechanical feature that facilitates safely carrying the device by means of using a strap.

11. An optional desktop device holder to facilitate the loading of medications.
